(19) United States
(12) Patent Application Publication
(10) Pub. No.: US 2007/0036991 A1
(43) Pub. Date: Feb. 15, 2007

(54) Film-forming composition, insulating film and production method thereof

(75) Inventor: Kensuke Morita, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/502,377

(22) Filed: Aug. 11, 2006

(30) Foreign Application Priority Data
Aug. 12, 2005 (JP) P2005-234497

(51) Int. Cl. B05D 3/02; B32B 9/04

(52) U.S. Cl. 428/446; 427/384

(57) ABSTRACT

A film-forming composition comprising at least one of a compound represented by formula (I) as defined in the specification, a hydrolysate of the compound represented by formula (I) and a polymerization product of at least one of the compound and the hydrolysate; an insulating film formed from the composition; and a production method thereof.

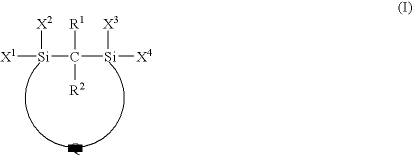

### BACKGROUND OF THE INVENTION

1. Field of the Invention

The present invention relates to a film-forming composition. More specifically, the present invention relates to an insulating film-forming composition ensuring that a coat having an appropriate uniform thickness can be formed as an interlayer insulating film material, for example, in a semiconductor device, and the dielectric properties and the like are excellent. The present invention also relates to a production method of an insulating film, and an insulating film.

2. Description of the Related Art

Conventionally, a silica (SiO₂) film formed by a vacuum process such as chemical vapor deposition (CVD) process has been often used as an interlayer insulating film in a semiconductor device or the like. In recent years, for the purpose of forming a more uniform interlayer insulating film, a coating-type insulating film mainly comprising a hydrolysis product of a tetraalkoxysilane, called an SOG (spin-on-glass) film, has come into use. Also, along with higher integration of a semiconductor device or the like, a low-dielectric interlayer insulating film mainly comprising a polyorganosiloxane, called an organic SOG, has been developed.

However, the dielectric constant of a CVD-SiO₂ film exhibiting a lowest dielectric constant among inorganic material films is on the order of 4. The dielectric constant of an SiOF film recently investigated as a low dielectric CVD film is approximately from 3.3 to 3.5, but this film has a problem that the hygroscopic property is high and the dielectric constant increases during use.

Under these circumstances, a method of using Compound A shown below as an insulating film material excellent in the dielectric constant and the Young's modulus is known (see, Science, Vol. 302, pp. 266-269 (2003)).

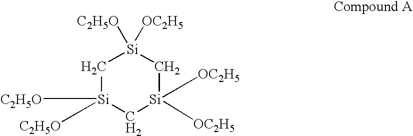

However, such a composition could not succeed in satisfying the dielectric constant and the film strength at the same time.

### SUMMARY OF THE INVENTION

Accordingly, the present invention relates to a polymer for solving those problems and also relates to a production method of an insulating film, and an insulating film formed by using the same. More specifically, an object of the present invention is to provide a composition capable of forming a silicone-based film with a uniform thickness suitable for use as an interlayer insulating film in a semiconductor device or the like, moreover, forming a film excellent in the dielectric properties and film strength; an insulating film; and a production method thereof. (An “insulating film” is also referred to as a “dielectric film” or a “dielectric insulating film”, and these terms are not substantially distinguished.)

The above-described object of the present invention can be attained by the following means.

(1) A film-forming composition comprising at least one of a compound represented by formula (I), a hydrolysate of the compound represented by formula (I) and a polymerization product of at least one of the compound and the hydrolysate: 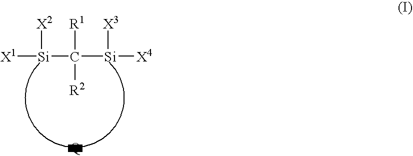
wherein R¹, R², X¹, X², X³ and X⁴ each independently represents a hydrogen atom or a substituent, provided that at least two members of X¹ to X⁴ represent a hydrolyzable group; and
Q represents a divalent atom or group necessary for forming a 4- or 5-membered ring together with Si—C—Si shown in formula (I).

(2) The film-forming composition as described in (1) above, which further comprises an organic solvent having a boiling point of 85° C. or more.

(3) The film-forming composition as described in (1) or (2) above, which further comprises an organic solvent having at least one of an ether group, an ester group and a ketone group.

(4) The film-forming composition as described in any of (1) to (3) above, which further comprises at least one of a nitric acid, an organic acid, an ammonia and an organic amine as a hydrolysis and condensation catalyst.

(5) The film-forming composition as described in any of (1) to (4) above, which further comprises an onium salt.

(6) The film-forming composition as described in any of (1) to (5) above, which further comprises at least one of a compound represented by formula (II), a hydrolysate of the compound represented by formula (II) and a polymerization product of at least one of the compound and the hydrolysate:
(R³)ₘ(X⁵)₄₋ₘSi (II)
wherein R³ represents a hydrogen atom, an alkyl group or an aryl group;
X⁵ represents a hydrolyzable group; and
m represents an integer of 0 to 3.

(7) The film-forming composition as described in any of (1) to (6) above,
wherein the ring formed by Q together with Si—C—Si shown in formula (I) is a 4-membered ring.

(8) The film-forming composition as described in any of (1) to (7) above,
wherein Q is a divalent hydrocarbon group.

(9) The film-forming composition as described in any of (1) to (8) above, which further comprises a pore-forming agent.

(10) An insulating film formed from a film-forming composition as described in any of (1) to (9) above.

(11) A method for producing an insulating film, comprising:
coating a composition as described in any of (1) to (9) above on a substrate; and
subjecting the coated composition to a heat treatment.

### DETAILED DESCRIPTION OF THE INVENTION

The present invention is described in detail below.

The film-forming composition of the present invention comprises a compound represented by formula (I), its hydrolysate or a polymerization product thereof. These may be present as a mixture. 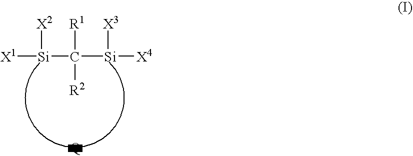
wherein R¹, R², X¹, X², X³ and X⁴ each independently represents a hydrogen atom or a substituent, provided that at least two members of X¹ to X⁴ represent a hydrolyzable group, and Q represents a divalent atom or group necessary for forming a 4- or 5-membered ring together with Si—C—Si shown in formula (I).

R¹ and R² each is independently a hydrogen atom or a substituent.

Examples of the substituent include a cyclic or chain alkyl group, an aryl group, an alkenyl group and an alkynyl group. R¹ and R² each is preferably a hydrogen atom.

X¹ to X⁴ each is independently a hydrogen atom or a substituent, and at least two members of X¹ to X⁴ are a hydrolyzable group. Examples of the hydrolyzable group include an alkoxy group, an aryloxy group, an acyloxy group and a chlorine atom. Among these, an alkoxy group is preferred, and an ethoxy group and a methoxy group are most preferred. Examples of the substituent other than the hydrolyzable group include a cyclic or chain alkyl group, an aryl group, an alkenyl group and an alkynyl group.

Q is a divalent atom or group necessary for forming a 4- or 5-membered ring together with Si—C—Si shown in formula (I). Examples of Q include an alkylene group, an alkenylene group, an arylene group, an oxygen atom and a sulfur atom. Among these, an alkylene group, an alkenylene group and an arylene group are preferred.

The ring formed by Q together with Si—C—Si shown in formula (I) is preferably a 4-membered ring. Q is most preferably a methylene group.

Specific examples of the compound represented by formula (I) are set forth below, but the present invention is not limited thereto.

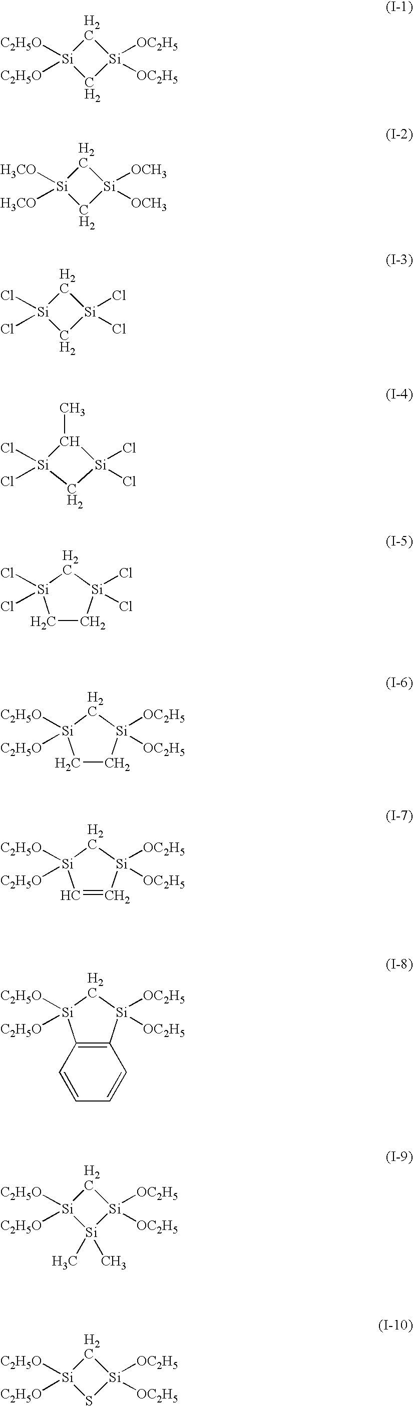

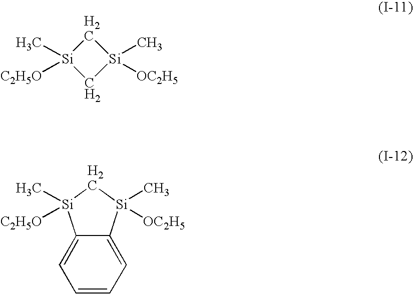

The compound represented by formula (I) can be synthesized according to the method described, for example, in J. Am. Chem. Soc., 99:10, 3273-3278 (1977).

The molecular weight of the compound represented by formula (I) is generally from 100 to 2,000, preferably from 150 to 1,000.

In the composition of the present invention, the concentration of the compound represented by formula (I), its hydrolysate or a polymerization product thereof is generally from 0.1 to 80 mass %, preferably from 1 to 50 mass %. (In this specification, mass ratio is equal to weight ratio.)

The composition of the present invention preferably comprises a compound represented by formula (II), its hydrolysate or a polymerization product thereof, in addition to a compound represented by formula (I), its hydrolysate or a polymerization product thereof:
(R³)ₘ(X⁵)₄₋ₘSi (II)
wherein R³ represents a hydrogen atom, an alkyl group or an aryl group, X⁵ represents a hydrolyzable group, and m represents an integer of 0 to 3. A plurality of R³s or X⁵s may be the same or different.

Preferred examples of R³ include a methyl group, an ethyl group, a propyl group, an isopropyl group, a cyclohexyl group and a phenyl group. Among these, a methyl group is most preferred.

Examples of X⁵ include an alkoxy group, an aryloxy group, a halogen atom and an acyloxy group. Among these, an alkoxy group is preferred, and a methoxy group and an ethoxy group are most preferred.

m is preferably 0 or 1.

The compound represented by formula (II) is most preferably tetramethoxysilane, tetraethoxysilane, methyltriethoxysilane or methyltrimethoxysilane.

In the composition of the present invention, the concentration of the compound represented by formula (II), its hydrolysate or a polymerization product thereof is generally from 0.01 to 70 mass %, preferably from 0.1 to 40 mass %.

At the hydrolysis and condensation of the silane compound represented by formula (I) or (II), water is preferably used in an amount of 0.5 to 150 mol, more preferably from 1 to 100 mol, per mol of the compound. If the amount of water added is less than 0.5 mol, the film may have poor cracking resistance, whereas if it exceeds 150 mol, precipitation or gelation of polymer may occur during the hydrolysis and condensation reaction.

In producing the composition of the present invention, a base catalyst or an acid catalyst is preferably used at the hydrolysis and condensation of the silane compound.

Examples of the base catalyst include sodium hydroxide, potassium hydroxide, lithium hydroxide, pyridine, pyrrole, piperazine, pyrrolidine, piperidine, picoline, monoethanolamine, diethanolamine, dimethylmonoethanolamine, monomethyldiethanolamine, triethanolamine, diazabicyclooctane, diazabicyclononane, diazabicycloundecene, tetramethylammonium hydroxide, tetraethylammonium hydroxide, tetrapropylammonium hydroxide, tetrabutylammonium hydroxide, ammonia, methylamine, ethylamine, propylamine, butylamine, pentylamine, hexylamine, pentylamine, octylamine, nonylamine, decylamine, N,N-dimethylamine, N,N-diethylamine, N,N-dipropylamine, N,N-dibutylamine, trimethylamine, triethylamine, tripropylamine, tributylamine, cyclohexylamine, trimethylimidine, 1-amino-3-methylbutane, dimethylglycine and 3-amino-3-methylamine. Among these, ammonia, an amine and an amine salt are preferred, ammonia and an organic amine are more preferred, and an alkylamine and a tetraalkylammonium hydroxide are most preferred. One of these alkaline catalysts may be used alone, or two or more thereof may be used simultaneously.

Examples of the acid catalyst include an inorganic acid such as hydrochloric acid, nitric acid, sulfuric acid, hydrofluoric acid, phosphoric acid, boric acid and oxalic acid; and an organic acid such as acetic acid, propionic acid, butanoic acid, pentanoic acid, hexanoic acid, heptanoic acid, octanoic acid, nonanoic acid, decanoic acid, oxalic acid, maleic acid, methylmalonic acid, adipic acid, sebacic acid, gallic acid, butyric acid, mellitic acid, arachidonic acid, shikimic acid, 2-ethylhexanoic acid, oleic acid, stearic acid, linolic acid, linoleic acid, salicylic acid, benzoic acid, p-aminobenzoic acid, p-toluenesulfonic acid, benzenesulfonic acid, monochloroacetic acid, dichloroacetic acid, trichloroacetic acid, trifluoroacetic acid, formic acid, malonic acid, sulfonic acids, phthalic acid, fumaric acid, citric acid, tartaric acid, succinic acid, fumaric acid, itaconic acid, mesaconic acid, citraconic acid, malic acid, a hydrolysate of glutaric acid, a hydrolysate of maleic anhydride, and a hydrolysate of phthalic anhydride.

A nitric acid and an organic carboxylic acid are preferred as the acid catalyst. One of these acid catalysts may be used alone, or two or more thereof may be used simultaneously.

The amount of this catalyst used is usually from 0.00001 to 10 mol, preferably from 0.00005 to 5 mol, per mol of the silane compound represented by formula (I). When the amount of the catalyst used is in this range, precipitation or gelation of polymer less occurs during the reaction. Also, in the present invention, the temperature at the condensation of the silane compound is usually from 0 to 100° C., preferably from 10 to 90° C.

It is also preferred that a nitric acid, an organic acid, ammonia, an organic amine or the like used as the hydrolysis and condensation catalyst remains and exists in the film-forming composition of the present invention.

The composition of the present invention may be coated on a support by using a solvent.

Preferred examples of the solvent which can be used include ethylene dichloride, cyclohexanone, cyclopentanone, 2-heptanone, methyl isobutyl ketone, γ-butyrolactone, methyl ethyl ketone, methanol, ethanol, dimethylimidazolidinone, ethylene glycol monomethyl ether, ethylene glycol monoethyl ether, ethylene glycol dimethyl ether, 2-methoxyethyl acetate, ethylene glycol monoethyl ether acetate, propylene glycol monomethyl ether (PGME), propylene glycol monomethyl ether acetate (PGMEA), tetraethylene glycol dimethyl ether, triethylene glycol monobutyl ether, triethylene glycol monomethyl ether, diethylene glycol dimethyl ether, diethylene glycol diethyl ether, isopropanol, ethylene carbonate, ethyl acetate, butyl acetate, methyl lactate, ethyl lactate, methyl methoxypropionate, ethyl ethoxypropionate, methyl pyruvate, ethyl pyruvate, propyl pyruvate, N,N-dimethylformamide, dimethylacetamide, dimethylsulfoxide, N-methylpyrrolidone, tetrahydrofuran, diisopropylbenzene, toluene, xylene and mesitylene. One of these solvents is used alone, or some species thereof are used as a mixture.

In order to achieve good uniformity of the film thickness, the boiling point of the solvent used is preferably 85° C. or more, more preferably from 85 to 250° C., still more preferably from 90 to 230° C., and most preferably from 95 to 200° C.

Also, from the standpoint of satisfying both the low dielectric constant and the high film strength, the solvent preferably contains an ether group or a carbonyl group.

In view of these points, preferred among the solvents described above are propylene glycol monomethyl ether acetate, propylene glycol monomethyl ether, 2-heptanone, cyclohexanone, γ-butyrolactone, ethylene glycol monomethyl ether, ethylene glycol monoethyl ether, ethylene glycol monoethyl ether acetate, propylene glycol monomethyl ether, propylene glycol monoethyl ether, diethylene glycol dimethyl ether, diethylene glycol diethyl ether, butyl acetate, methyl lactate, ethyl lactate, methyl methoxypropionate, ethyl ethoxypropionate, N-methylpyrrolidone, N,N-dimethylformamide and methyl isobutyl ketone.

The composition of the present invention preferably contains an onium salt. Examples of the onium salt include an ammonium salt, a phosphonium salt, an arsonium salt, a stibonium salt, an oxonium salt, a sulfonium salt, a selenonium salt, a stannonium salt and an iodonium salt. Among these, an ammonium salt is preferred because the stability of the composition is more excellent.

Examples of the ammonium salt include tetramethylammonium oxide, tetramethylammonium chloride, tetramethylammonium bromide, tetramethylammonium fluoride, tetrabutylammonium oxide, tetrabutylammonium chloride, tetrabutylammonium bromide, tetrabutylammonium fluoride, tetramethylammonium nitrate, tetramethylammonium acetate, tetramethylammonium propionate, tetramethylammonium maleate and tetramethylammonium sulfate.

Among these ammonium salts, from the standpoint of enhancing the electrical properties of the silica-based coating film, preferred are ammonium salts such as tetramethylammonium nitrate, tetramethylammonium acetate, tetramethylammonium propionate, tetramethylammonium maleate and tetramethylammonium sulfate.

The amount of the onium salt added is generally from 0.0001 to 10 mass %, preferably from 0.001 to 5 mass %, based on the composition.

The film is preferably made porous by adding a pore-forming agent such as thermally decomposable polymer and surfactant to the composition of the present invention, so as to more reduce the dielectric constant. The pore-forming agent is a compound of being removed from a matrix by means of heating or the like after the matrix structure of the film is formed, and thereby forming pores.

Examples of the thermally decomposable polymer include a vinyl ether-based compound, a polyoxyethylene unit-containing vinyl-based compound, a polyoxypropylene unit-containing vinyl-based compound, a vinylpyridine-based compound, a styrene-based compound, a vinyl alkyl ester-based compound, a (meth)acrylate acid-based compound, a polyoxyalkylene unit-containing polymer and a polycarbonate polymer. In view of the decomposition properties and the mechanical strength of film, a polyoxyalkylene unit-containing polymer is preferred.

Examples of the surfactant include a nonionic surfactant and a quaternary ammonium salt-type surfactant, with a quaternary ammonium salt-type surfactant being preferred.

The pore-forming agent content is preferably from 5 to 80%, more preferably from 10 to 70%, still more preferably from 15 to 60%, based on the entire mass of solid matters in the composition of the present invention.

The entire solid content concentration of the thus-obtained composition of the present invention is preferably from 2 to 30 mass %, and this concentration is appropriately adjusted according to the intended purpose. When the entire solid content concentration of the composition is from 2 to 30 mass %, the coat can have an appropriate film thickness, and the coating solution can have higher storage stability.

In coating the thus-obtained insulating film-forming material of the present invention on a substrate such as silicon wafer, SiO₂ wafer and SiN wafer, coating means such as spin-coating, dipping, roll coating and spraying is employed.

At this time, as for the film thickness, a coat having a dry thickness of approximately from 0.05 to 1.5 μm by single coating or approximately from 0.1 to 3 μm by double coating can be formed. Thereafter, the coat is dried at an ordinary temperature or heated by using a hot plate, an oven, a furnace or the like, whereby an insulating film comprising a vitreous polymer, a macropolymer or a mixture thereof can be formed.

As for the heating atmosphere here, the heating may be performed, for example, in a nitrogen atmosphere, in an argon atmosphere or in vacuum, but firing under the condition that the maximum firing temperature is from 300 to 430° C. is preferred.

More specifically, the insulating film-forming material of the present invention is coated on a substrate (usually a substrate with metal wiring) by, for example, spin coating, and the coat is subjected to a preheat treatment to dry the solvent and then to a final heat treatment (annealing) at a temperature of 300 to 430° C., whereby an insulating film having a low dielectric constant can be formed.

### EXAMPLES

The present invention is described in greater detail below by referring to Examples. In Examples, unless otherwise indicated, the “parts” and “%” denote “parts by mass” and “mass %”, respectively.

### Synthesis Example 1

Compound (I-1) was synthesized by using the method described in J. Am. Chem. Soc., 99:10, 3273-3278 (1977).

### Synthesis Example 2

A mixture containing 0.03 ml of 70% nitric acid and 21.64 ml of water was added dropwise to a solution obtained by dissolving 79 g of Compound (I-1) in 200 g of propylene glycol monomethyl ether. After the completion of dropwise addition, the reaction was allowed to proceed for 15 minutes and the reaction product was concentrated under reduced pressure to produce 179 g of Composition (1-1) of the present invention.

### Synthesis Example 3

A mixture containing 0.12 ml of 70% nitric acid and 21.64 ml of water was added dropwise to a solution obtained by dissolving 41.25 g of tetraethoxysilane in 145 g of diethylene glycol diethyl ether. After the completion of dropwise addition, the reaction was allowed to proceed for 1 hour, and 23.8 g of Compound (I-1) was added dropwise thereto, followed by stirring. Subsequently, the reaction product was concentrated under reduced pressure to obtain 139 g of a solution, and then 6.96 g of polypropylene glycol as the pore-forming agent and 3 g of an aqueous 4% tetramethylammonium nitrate solution were added and dissolved with stirring at room temperature for 30 minutes to produce Composition (1-2) of the present invention.

### Synthesis Example 4

A mixture containing 0.05 ml of 36% hydrochloric acid and 21.64 ml of water was added dropwise to a solution obtained by dissolving 79 g of Compound A described in Science, Vol. 302, pp. 266-269 (2003) in 170 g of ethanol. After the completion of dropwise addition, the reaction was allowed to proceed for 15 minutes to produce Composition (A-1) for comparison.

The compositions of Synthesis Examples 2 to 4 each was filtered through a Teflon (registered trademark)-made filter having a pore size of 0.2 μm and then coated on a 4-inch silicon wafer by spin coating, and the substrate was dried on a hot plate at 130° C. for 1 minute and subsequently at 230° C. for 1 minute and furthermore heated in a clean oven under nitrogen atmosphere at 400° C. for 30 minutes to form a coat. The relative dielectric constant was calculated from the capacity value measured at 1 MHz by using a mercury probe manufactured by Four Dimension and an LCR meter HP4285A manufactured by Yokogawa Hewlett-Packard (measurement temperature: 25° C.). Also, the Young's modulus was measured by using Nano-Indenter SA2 manufactured by MTS (measurement temperature: 25° C.).

The evaluation results are shown in Table 1.

TABLE 1

| | Relative Dielectric | Young's Modulus |
|---|---|---|
| Composition | Constant | (GPa) |
| I-1 (Invention) | 2.99 | 16 |
| I-2 (Invention) | 2.41 | 6 |
| A-1 (Comparison) | 3.43 | 16 |

It is seen that when the composition of the present invention is used, a film having a low dielectric constant and a high Young's modulus can be formed.

According to the present invention, an insulating film excellent in the dielectric properties and film strength, which is suitable for use as an interlayer insulating film in a semiconductor device or the like, can be formed.

The entire disclosure of each and every foreign patent application from which the benefit of foreign priority has been claimed in the present application is incorporated herein by reference, as if fully set forth.

What is claimed is:

1. A film-forming composition comprising at least one of a compound represented by formula (I), a hydrolysate of the compound represented by formula (I) and a polymerization product of at least one of the compound and the hydrolysate: 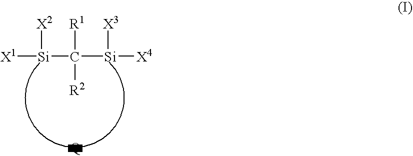
wherein R¹, R², X¹, X², X³ and X⁴ each independently represents a hydrogen atom or a substituent, provided that at least two members of X¹ to X⁴ represent a hydrolyzable group; and
Q represents a divalent atom or group necessary for forming a 4- or 5-membered ring together with Si—C—Si shown in formula (I).

2. The film-forming composition according to claim 1, which further comprises an organic solvent having a boiling point of 85° C. or more.

3. The film-forming composition according to claim 1, which further comprises an organic solvent having at least one of an ether group, an ester group and a ketone group.

4. The film-forming composition according to claim 1, which further comprises at least one of a nitric acid, an organic acid, an ammonia and an organic amine as a hydrolysis and condensation catalyst.

5. The film-forming composition according to claim 1, which further comprises an onium salt.

6. The film-forming composition according to claim 1, which further comprises at least one of a compound represented by formula (II), a hydrolysate of the compound represented by formula (II) and a polymerization product of at least one of the compound and the hydrolysate:
(R³)ₘ(X⁵)₄₋ₘSi (II)
wherein R³ represents a hydrogen atom, an alkyl group or an aryl group;
X⁵ represents a hydrolyzable group; and
m represents an integer of 0 to 3.

7. The film-forming composition according to claim 1,
wherein the ring formed by Q together with Si—C—Si shown in formula (I) is a 4-membered ring.

8. The film-forming composition according to claim 1, wherein Q is a divalent hydrocarbon group.

9. The film-forming composition according to claim 1, which further comprises a pore-forming agent.

10. An insulating film formed from a film-forming composition according to claim 1.

11. A method for producing an insulating film, comprising:
coating a composition according to claim 1 on a substrate; and
subjecting the coated composition to a heat treatment.
